(19) United States
(12) Patent Application Publication
(10) Pub. No.: US 2025/0226547 A1
(43) Pub. Date: Jul. 10, 2025

(54) SECONDARY BATTERY

(71) Applicant: MURATA MANUFACTURING CO., LTD., Kyoto (JP)

(72) Inventor: Motohisa SUZUKI, Kyoto (JP)

(21) Appl. No.: 19/090,895

(22) Filed: Mar. 26, 2025

Related U.S. Application Data
(63) Continuation of application No. PCT/JP2023/040903, filed on Nov. 14, 2023.

(30) Foreign Application Priority Data
Mar. 24, 2023 (JP) 2023-048375

(51) Int. Cl. H01M 50/533; H01M 10/0587; H01M 50/109

(52) U.S. Cl. CPC H01M 50/533; H01M 10/0587; H01M 50/109

(57) ABSTRACT

A secondary battery is provided and includes a battery device, an external terminal, and a lead. The battery device includes a first electrode and a second electrode that are stacked with a separator interposed between the first electrode and the second electrode, and are wound around a winding axis extending in a first direction. The lead includes two opposed edges, and couples the first electrode and the external coupling terminal to each other. The first electrode includes a first electrode current collector and a first electrode active material layer. The first electrode current collector includes a first edge. The first electrode active material layer covers a portion of the first electrode current collector. The lead is joined to the first electrode current collector in a state where the two opposed edges are inclined relative to the first edge.

### CROSS REFERENCE TO RELATED APPLICATIONS

The present application is a continuation of International Application No. PCT/JP2023/040903, filed on Nov. 14, 2023, which claims priority to Japanese Patent Application No. 2023-048375, filed on Mar. 24, 2023, the entire contents of which are incorporated herein by reference.

### BACKGROUND

The present disclosure relates to a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode, and an electrolyte that are contained inside an outer package member. A configuration of the secondary battery has been considered in various ways.

For example, a sealed electrical storage device is disclosed and including an electrode body and an outer package casing. The electrode body includes a positive electrode body and a negative electrode body that are stacked or wound with a separator interposed therebetween. The outer package casing contains the electrode body.

### SUMMARY

The present disclosure relates to a secondary battery.

Consideration has been given in various ways to improve performance of a secondary battery. However, there is room for improvement in terms of the performance of the secondary battery.

It is therefore desirable to provide a secondary battery having higher reliability.

A secondary battery according to an embodiment of the present disclosure includes a battery device, an external coupling terminal, and a lead. The battery device includes a first electrode and a second electrode that are stacked with a separator interposed between the first electrode and the second electrode, and are wound around a winding axis extending in a first direction. The lead includes two opposed edges, and couples the first electrode and the external coupling terminal to each other. The first electrode includes a first electrode current collector and a first electrode active material layer. The first electrode current collector includes a first edge. The first electrode active material layer covers a portion of the first electrode current collector. The lead is joined to the first electrode current collector in a state where the two opposed edges are inclined relative to the first edge of the first electrode current collector.

According to the secondary battery of an embodiment of the present disclosure, the lead joined to the first electrode current collector includes the two opposed edges that are inclined relative to the first edge of the first electrode current collector. This reduces stress that is to be applied to a part of the first electrode current collector that is joined to the lead. This makes it possible to reduce a decrease in strength of the first electrode current collector and to avoid cracking and breakage of the first electrode current collector, thus allowing the secondary battery according to an embodiment of the present disclosure to have higher reliability.

Note that effects of the present disclosure are not necessarily limited to those described herein and may include any of a series of effects in relation to the present technology.

### BRIEF DESCRIPTION OF THE FIGURES

FIG. 1 is a perspective diagram illustrating a configuration of a secondary battery according to an embodiment of the present disclosure.

FIG. 2 is a vertical sectional diagram illustrating the configuration of the secondary battery illustrated in FIG. 1.

FIG. 3 is a sectional diagram illustrating a configuration of a battery device illustrated in FIG. 2.

FIG. 4A is a schematic developed view of a positive electrode of the battery device illustrated in FIG. 3.

FIG. 4B is a schematic developed view of a negative electrode of the battery device illustrated in FIG. 3.

FIG. 5 is a horizontal sectional diagram illustrating the configuration of the secondary battery illustrated in FIG. 1.

FIG. 6 is an enlarged plan view of a negative electrode lead and the vicinity thereof illustrated in FIG. 4B.

FIG. 7 is an exploded perspective diagram for describing a process of manufacturing the secondary battery illustrated in FIG. 1.

FIG. 8A is a partial enlarged sectional diagram illustrating, in an enlarged manner, a portion of the battery device illustrated in FIG. 5.

FIG. 8B is a partial enlarged sectional diagram illustrating, in an enlarged manner, a portion of the battery device illustrated in FIG. 2.

FIG. 9 is an enlarged plan view of a portion of a negative electrode according to an embodiment.

FIG. 10 is an enlarged plan view of a portion of a negative electrode according to an embodiment.

FIG. 11 is an enlarged plan view of a portion of a negative electrode according to an embodiment.

FIG. 12 is an enlarged plan view of a portion of a negative electrode according to an embodiment.

FIG. 13 is an enlarged plan view of a portion of a negative electrode according to an embodiment.

FIG. 14 is an enlarged plan view of a portion of a negative electrode according to a comparative example.

### DETAILED DESCRIPTION

The present disclosure is described below in further detail including with reference to the drawings according to an embodiment.

A description is given first of a secondary battery according to an embodiment of the present disclosure.

The secondary battery to be described here has an external appearance of a flat and columnar three-dimensional shape, and is commonly referred to as, for example, a coin type or a button type. As will be described later, the secondary battery includes two bottom parts opposed to each other, and a sidewall part positioned between the two bottom parts. The secondary battery has a height smaller than an outer diameter. Herein, the “outer diameter” refers to a maximum diameter (a maximum outer diameter) of the bottom parts. In the secondary battery, the two bottom parts opposed to each other have respective maximum diameters that are substantially equal to each other. Herein, the “height” refers to a maximum distance from an upper surface of one of the bottom parts to a lower surface of another of the bottom parts. Note that in the present embodiment, a direction in which the two bottom parts are opposed to each other corresponds to a height direction Z.

Although a charge and discharge principle of the secondary battery is not particularly limited, the following description deals with a case where a battery capacity is obtained using insertion and extraction of an electrode reactant. The secondary battery includes a positive electrode, a negative electrode, and an electrolyte. In the secondary battery, to prevent precipitation of the electrode reactant on a surface of the negative electrode during charging, a charge capacity of the negative electrode is greater than a discharge capacity of the positive electrode. In other words, an electrochemical capacity per unit area of the negative electrode is set to be greater than an electrochemical capacity per unit area of the positive electrode. Note that the secondary battery according to the present embodiment is a high-charge-voltage secondary battery that is configured to achieve a favorable cyclability characteristic with no decrease in energy density, even if the secondary battery is charged with a high voltage of 4.38 V or higher.

Although not particularly limited in kind, the electrode reactant is specifically a light metal such as an alkali metal or an alkaline earth metal. Examples of the alkali metal include lithium, sodium, and potassium. Examples of the alkaline earth metal include beryllium, magnesium, and calcium.

Examples are given below of a case in which the electrode reactant is lithium. A secondary battery in which a battery capacity is obtained through insertion and extraction of lithium is what is called a lithium-ion secondary battery. In the lithium-ion secondary battery, lithium is inserted and extracted in an ionic state.

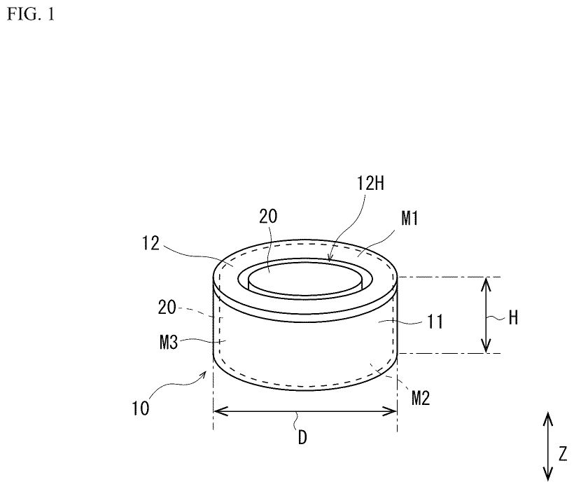

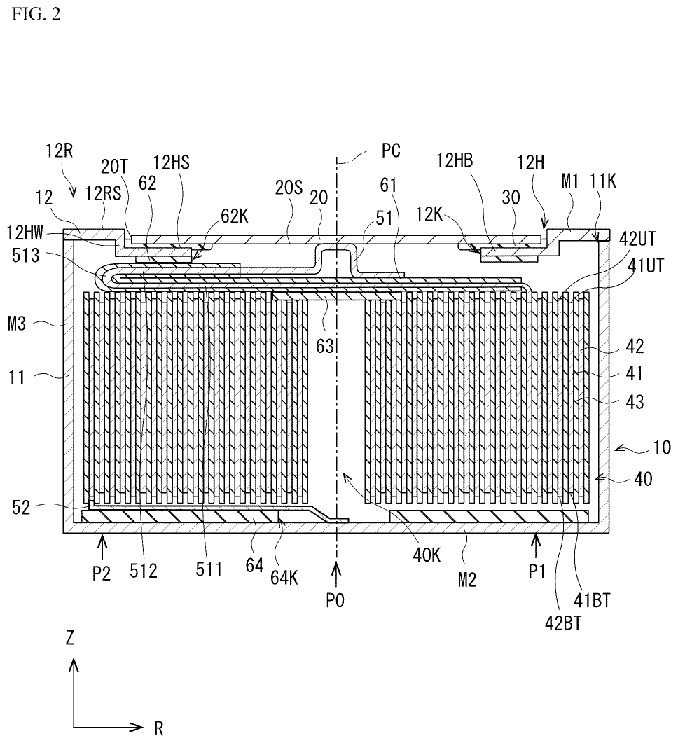

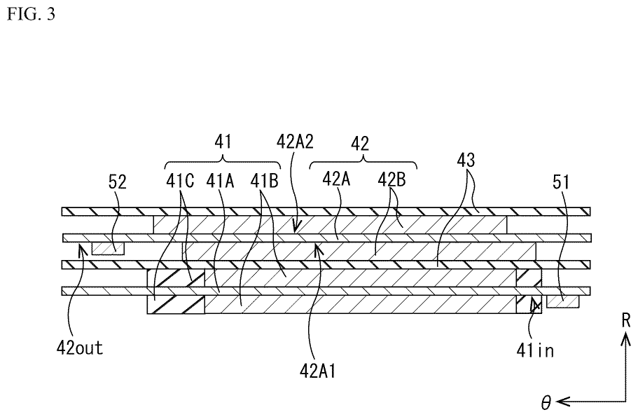

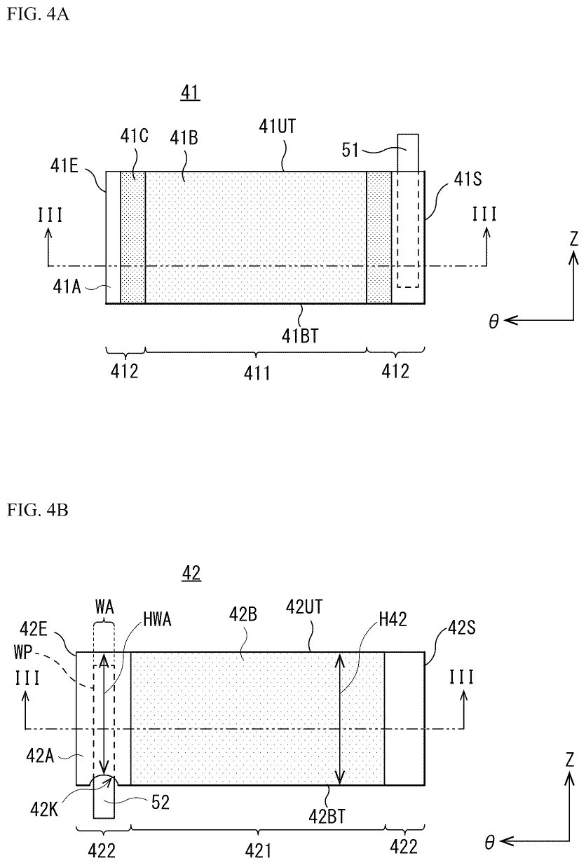

FIG. 1 illustrates a perspective configuration of the secondary battery. FIG. 2 illustrates a sectional configuration of the secondary battery illustrated in FIG. 1. FIG. 3 illustrates a sectional configuration of a battery device 40 illustrated in FIG. 2 in an unwound state. Further, FIG. 4A is a developed view of a positive electrode 41 (to be described later) of the battery device 40, and schematically illustrates a state before the positive electrode 41 is wound. FIG. 4B is a developed view of a negative electrode 42 (to be described later) of the battery device 40, and schematically illustrates a state before the negative electrode 42 is wound.

For convenience, the following description is given with an upper side in a sheet plane of each of FIGS. 1 and 2 assumed to be an upper side of the secondary battery, and a lower side in the sheet plane of each of FIGS. 1 and 2 assumed to be a lower side of the secondary battery.

The secondary battery to be described here has a three-dimensional shape in which a height H is smaller than an outer diameter D, as illustrated in FIG. 1. In other words, the secondary battery has a flat and columnar three-dimensional shape. Here, the three-dimensional shape of the secondary battery is flat and cylindrical (circular columnar). Note that, in the present embodiment, an up-down direction in the sheet plane in each of FIGS. 1 and 2 is assumed to be the height direction Z. Accordingly, the height H means a dimension, of the secondary battery of the present embodiment, in the height direction Z. The outer diameter D means a dimension, of the secondary battery of the present embodiment, in a direction orthogonal to the height direction Z.

Dimensions of the secondary battery are not particularly limited. However, for example, the outer diameter D is within a range from 3 mm to 30 mm both inclusive, and the height H is within a range from 0.5 mm to 70 mm both inclusive. Note that a ratio of the outer diameter D to the height H, i.e., D/H, is greater than 1. In other words, the outer diameter D is greater than the height H. Although not particularly limited, an upper limit of the ratio (D/H) is preferably 25 or less.

As illustrated in FIGS. 1 to 3, the secondary battery includes an outer package can 10, an external terminal 20, the battery device 40, and a positive electrode lead 51. In the configuration example illustrated in FIG. 2, the secondary battery further includes a gasket 30, a negative electrode lead 52, a sealant 61, and insulating films 62 and 63.

As illustrated in FIGS. 1 and 2, the outer package can 10 is a hollow outer package member to contain the battery device 40 and other components. The outer package can 10 includes an electrically conductive material. Note that the outer package can 10 corresponds to a specific example of an “external coupling terminal” in the present disclosure.

In the configuration example illustrated in FIG. 1, the outer package can 10 has a flat and substantially circular columnar three-dimensional shape corresponding to the three-dimensional shape of the secondary battery that is flat and circular columnar. Accordingly, the outer package can 10 includes two bottom parts M1 and M2 opposed to each other, and a sidewall part M3 positioned between the bottom part M1 and the bottom part M2. That is, the sidewall part M3 couples the bottom part M1 and the bottom part M2 to each other, and surrounds the battery device 40. The sidewall part M3 has an upper end part coupled to the bottom part M1, and a lower end part coupled to the bottom part M2. As described above, the outer package can 10 is substantially circular columnar. The bottom parts M1 and M2 are each circular in plan shape, and a surface of the sidewall part M3 is a convexly curved surface.

The outer package can 10 includes a container part 11 and a cover part 12 that are welded to each other. That is, an internal space of the outer package can 10 is sealed by the cover part 12 being welded to the container part 11. Note that in the present embodiment, the bottom part M1 forms the cover part 12, and the bottom part M2 and the sidewall part M3 together form the container part 11. Accordingly, an outer edge of the cover part 12 is welded to the upper end part of the sidewall part M3.

The container part 11 is a container member that is to contain the battery device 40 and other components inside, and has a flat and circular columnar shape. The container part 11 has a hollow structure with an upper end part open and a lower end part closed. That is, the container part 11 has an opening 11K (FIG. 2) at the upper end part. The opening 11K serves as a passing-through hole through which the battery device 40 is passable in the height direction Z.

The cover part 12 is a substantially disk-shaped cover member that closes the opening 11K of the container part 11, and has a through hole 12K. The through hole 12K is used as a coupling path for coupling the battery device 40 and the external terminal 20 to each other. The cover part 12 is welded to the container part 11 at the opening 11K, as described above. The external terminal 20 is attached to the cover part 12 with the gasket 30 interposed therebetween. That is, the cover part 12 supports the external terminal 20 with the gasket 30 interposed therebetween. The external terminal 20 is so attached to the cover part 12, with the gasket 30 interposed therebetween, as to close the through hole 12K. The external terminal 20 is electrically insulated from the outer package can 10.

In the secondary battery having been completed, the cover part 12 is in a state of having been welded to the container part 11 as described above. The opening 11K has been closed by the cover part 12 as described above. It may thus seem that whether the container part 11 has had the opening 11K is no longer recognizable from an external appearance of the secondary battery.

However, if the cover part 12 is welded to the container part 11, welding marks remain on a surface of the outer package can 10, more specifically, at a boundary part between the container part 11 and the cover part 12. Whether the container part 11 has had the opening 11K is recognizable afterward by checking the presence or absence of the welding marks.

Specifically, the welding marks remaining on the surface of the outer package can 10 indicates that the container part 11 has had the opening 11K. In contrast, no welding marks remaining on the surface of the outer package can 10 indicates that the container part 11 has had no opening 11K.

The cover part 12 is so bent as to partly protrude along the height direction Z toward an inside of the container part 11 and thus includes a recessed part 12H. Specifically, as viewed from outside the outer package can 10, the cover part 12 has a shape that is partly recessed in the height direction Z toward the battery device 40 contained inside the outer package can 10. The recessed part 12H has the through hole 12K provided through the cover part 12 in the height direction Z, a bottom part 12HB surrounding the through hole 12K along a horizontal plane orthogonal to the height direction Z, and a wall part 12HW provided upright along an outer edge of the bottom part 12HB.

A portion of the cover part 12 other than the recessed part 12H is a peripheral part 12R. The peripheral part 12R is provided to surround the recessed part 12H and has an annular shape in the horizontal plane orthogonal to the height direction Z of the secondary battery. The peripheral part 12R is a portion that surrounds a periphery of the recessed part 12H and protrudes away from the battery device 40 along the height direction Z. Accordingly, a surface 12HS of the bottom part 12HB of the recessed part 12H is at a low position in the height direction Z toward the inside of the container part 11 as compared with a surface 12RS of the peripheral part 12R. In other words, a distance from the surface 12HS of the bottom part 12HB of the recessed part 12H to the battery device 40 in the height direction Z is shorter than a distance from the surface 12RS of the peripheral part 12R to the battery device 40 in the height direction Z.

A shape of the recessed part 12H in a plan view, that is, a shape defined by an outer edge of the recessed part 12H when the secondary battery is viewed from above, is not particularly limited. Here, the recessed part 12H has a substantially circular shape in a plan view. Note that an inner diameter and a depth of the recessed part 12H are each not particularly limited and may be set as desired. However, the depth of the recessed part 12H is so set as to allow a height position of a surface 20S of the external terminal 20 to be lower than a height position of the surface 12RS of the peripheral part 12R, in a state where the external terminal 20 is attached to the recessed part 12H with the gasket 30 interposed therebetween.

As described above, the outer package can 10 is what is called a welded can in which the container part 11 and the cover part 12 that have been physically separate from each other are welded to each other. Thus, the outer package can 10 after the welding is a single member that is physically integral as a whole, and is therefore in a state of being not separable into the container part 11 and the cover part 12 afterward.

The outer package can 10 that is a welded can is different from a crimped can formed by crimping processing, and is what is called a crimpless can. One reason for this is to increase a device space volume inside the outer package can 10 and to thereby increase an energy density per unit volume. The “device space volume” refers to a volume (an effective volume) of the internal space of the outer package can 10 available for containing the battery device 40.

Further, the outer package can 10 that is the welded can does not include any portion folded over another portion, and does not include any portion in which two or more members lie over each other.

The wording “does not include any portion folded over another portion” means that the outer package can 10 is not so processed (subjected to bending processing) as to include a portion folded over another portion. The wording “does not include any portion in which two or more members lie over each other” means that the outer package can 10 after completion of the secondary battery is physically a single member and is thus not separable into two or more members afterward. That is, the outer package can 10 in the secondary battery having been completed is not in a state where two or more members lie over each other and are so combined with each other as to be separable from each other afterward.

Here, the outer package can 10 is electrically conductive. To be more specific, the container part 11 and the cover part 12 are each electrically conductive. The outer package can 10 is electrically coupled to the negative electrode 42 of the battery device 40 via the negative electrode lead 52. Accordingly, the outer package can 10 also serves as an external coupling terminal of the negative electrode 42. The secondary battery of the present embodiment does not require the external coupling terminal of the negative electrode 42 separate from the outer package can 10, and thus suppresses a decrease in device space volume resulting from providing the external coupling terminal of the negative electrode 42. As a result, the device space volume increases, and the energy density per unit volume increases accordingly.

Specifically, the outer package can 10 is a metal can that includes any one or more of electrically conductive materials including, without limitation, a metal material and an alloy material. Examples of the electrically conductive material included in the metal can include iron, copper, nickel, stainless steel, an iron alloy, a copper alloy, and a nickel alloy. The stainless steel is not particularly limited in kind, and specific examples thereof include SUS304 and SUS316. Note that the container part 11 and the cover part 12 may include respective materials that are the same as or different from each other.

The cover part 12 is insulated, via the gasket 30, from the external terminal 20 serving as an external coupling terminal of the positive electrode 41. One reason for this is to prevent contact, or a short circuit, between the outer package can 10 that is the external coupling terminal of the negative electrode 42 and the external terminal 20 that is the external coupling terminal of the positive electrode 41.

As illustrated in FIGS. 1 and 2, the external terminal 20 is a coupling terminal to be coupled to electronic equipment when the secondary battery is mounted on the electronic equipment. As described above, the external terminal 20 is attached to the cover part 12 of the outer package can 10 to be supported by the cover part 12. The external terminal 20 is provided at a position that is on an opposite side of the cover part 12 to the bottom part M2 and at which the external terminal 20 overlaps the through hole 12K in the height direction Z.

Here, the external terminal 20 is coupled to the positive electrode 41 of the battery device 40 via the positive electrode lead 51. The external terminal 20 thus serves as the external coupling terminal of the positive electrode 41. Accordingly, upon use of the secondary battery, the secondary battery is coupled to electronic equipment via the external terminal 20 serving as the external coupling terminal of the positive electrode 41 and the outer package can 10 serving as the external coupling terminal of the negative electrode 42. This allows the electronic equipment to operate by using the secondary battery as a power source.

The external terminal 20 is a flat and substantially plate-shaped member that extends along a horizontal plane orthogonal to the height direction Z of the secondary battery, and is disposed inside the recessed part 12H with the gasket 30 interposed between the external terminal 20 and the recessed part 12H. The external terminal 20 is insulated from the cover part 12 via the gasket 30. Here, as illustrated in FIG. 2, a position of the surface 20S of the external terminal 20 is low in the height direction Z toward the battery device 40 as compared with a position of the surface 12RS of the peripheral part 12R of the outer package can 10. In other words, the external terminal 20 is contained inside the recessed part 12H in such a manner that the surface 20S, which is an upper end of the external terminal 20, is recessed toward the battery device 40 as compared with the surface 12RS. In the secondary battery of the present embodiment, the height of the secondary battery is reduced as compared with when the external terminal 20 protrudes above the cover part 12. This increases the energy density per unit volume of the secondary battery. This also makes it possible to prevent a short circuit between the outer package can 10 and the external terminal 20 from being caused by another electrically conductive member. Further, in the present embodiment, a peripheral portion of the external terminal 20 overlaps the bottom part 12HB of the recessed part 12H in the height direction Z. Owing to the external terminal 20 and the cover part 12 having such an overlap portion, it is possible to improve mechanical strength of the secondary battery as a whole. Here, a length, of the overlap portion of the external terminal 20 and the peripheral portion, along a horizontal plane orthogonal to the height direction Z is preferably greater than a thickness of the external terminal 20 and greater than a thickness of the bottom part 12HB.

Note that the external terminal 20 has an outer diameter smaller than the inner diameter of the recessed part 12H. An outer edge 20T of the external terminal 20 is thus spaced from the cover part 12. The gasket 30 is disposed in only a portion of a region between the external terminal 20 and the cover part 12 (the recessed part 12H). More specifically, the gasket 30 is disposed only at a location where the external terminal 20 and the cover part 12 would be in contact with each other if it were not for the gasket 30. However, the gasket 30 is preferably also provided between an inner wall face of the wall part 12HW of the recessed part 12H and the outer edge 20T of the external terminal 20. Further, the cover part 12 and the external terminal 20 are preferably stuck to each other by the gasket 30.

Further, the external terminal 20 includes any one or more of electrically conductive materials including, without limitation, a metal material and an alloy material. Examples of the electrically conductive materials include aluminum and an aluminum alloy. However, the external terminal 20 may include a cladding material. The cladding material includes an aluminum layer and a nickel layer disposed in order from a side closer to the gasket 30. In the cladding material, the aluminum layer and the nickel layer are roll-bonded to each other.

The gasket 30 is an insulating member disposed between the outer package can 10 (the cover part 12) and the external terminal 20, as illustrated in FIG. 2. The external terminal 20 is fixed to the cover part 12 with the gasket 30 interposed therebetween. The gasket 30 is ring-shaped in a plan view and has a through hole at a location corresponding to the through hole 12K. The gasket 30 includes any one or more of insulating materials including, without limitation, a polymer compound having an insulating property. Examples of the insulating materials include a resin such as polypropylene or polyethylene.

A range of placement of the gasket 30 is not particularly limited, and may be chosen as desired. Here, the gasket 30 is disposed in a gap between an upper surface of the cover part 12 and a lower surface of the external terminal 20, inside the recessed part 12H. However, as described above, the gasket 30 is preferably also provided between the inner wall face of the wall part 12HW of the recessed part 12H and the outer edge 20T of the external terminal 20. Further, the cover part 12 and the external terminal 20 are preferably stuck to each other by the gasket 30.

The battery device 40 is a power generation device that causes charging and discharging reactions to proceed. As illustrated in FIGS. 2 and 3, the battery device 40 is contained inside the outer package can 10. The battery device 40 includes the positive electrode 41 and the negative electrode 42. Here, the battery device 40 further includes a separator 43 and an electrolytic solution. The electrolytic solution is a liquid electrolyte, and is not illustrated. Note that the battery device 40 corresponds to a specific example of a “battery device” in the present disclosure.

A center line PC illustrated in FIG. 2 is a line segment corresponding to a center of the battery device 40 in a direction along the outer diameter D of the secondary battery (the outer package can 10). More specifically, a position P0 of the center line PC corresponds to a position of the center of the battery device 40.

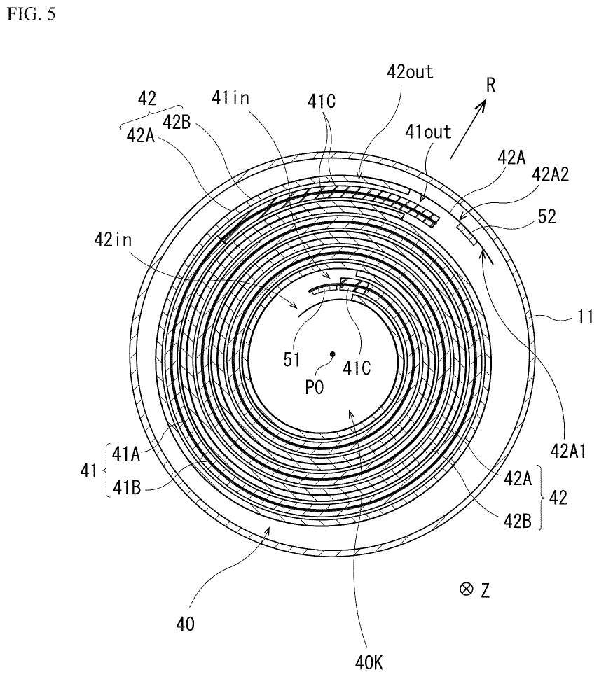

The battery device 40 is what is called a wound electrode body. More specifically, in the battery device 40, for example, the positive electrode 41 and the negative electrode 42 are stacked on each other in a radial direction R with the separator 43 interposed therebetween, as illustrated in FIGS. 2 and 3. The radial direction R is a radial direction of the outer package can 10. In addition, the stack of the positive electrode 41, the negative electrode 42, and the separator 43 is wound around the center line PC as a winding axis, as illustrated in FIG. 5. The positive electrode 41 and the negative electrode 42 are wound, remaining in a state of being opposed to each other with the separator 43 interposed therebetween. As a result, a winding center space 40K is present at the center of the battery device 40. FIG. 5 illustrates a configuration example of the battery device 40 along a horizontal section orthogonal to the height direction Z. Note that, in order to secure visibility, FIG. 5 omits illustration of the separator 43.

Here, the positive electrode 41, the negative electrode 42, and the separator 43 are so wound that the separator 43 is disposed in each of an outermost wind of the wound electrode body and an innermost wind of the wound electrode body. Respective numbers of winds of the positive electrode 41, the negative electrode 42, and the separator 43 are not particularly limited, and may be chosen as desired. In addition, the negative electrode 42 is positioned on an outer side relative to the positive electrode 41, in an outermost wind of the battery device 40. In other words, as illustrated in FIG. 5, an outermost positive electrode wind part 41out positioned in an outermost wind of the positive electrode 41 included in the battery device 40 is positioned on an inner side relative to an outermost negative electrode wind part 42out positioned in an outermost wind of the negative electrode 42 included in the battery device 40. Here, the outermost positive electrode wind part 41out is a part corresponding to the outermost one wind of the positive electrode 41 in the battery device 40. The outermost negative electrode wind part 42out is a part corresponding to the outermost one wind of the negative electrode 42 in the battery device 40. In contrast, in an innermost wind of the battery device 40, the negative electrode 42 is preferably positioned on the inner side relative to the positive electrode 41. In other words, as illustrated in FIG. 5, an innermost negative electrode wind part 42 in that is positioned in an innermost wind of the negative electrode 42 included in the battery device 40 is preferably positioned on the inner side relative to an innermost positive electrode wind part 41 in that is positioned in an innermost wind of the positive electrode 41 included in the battery device 40. Here, the innermost positive electrode wind part 41in is a part corresponding to the innermost one wind of the positive electrode 41 in the battery device 40. The innermost negative electrode wind part 42 in is a part corresponding to the innermost one wind of the negative electrode 42 in the battery device 40.

The battery device 40 has a three-dimensional shape similar to the three-dimensional shape of the outer package can 10. Specifically, the battery device 40 has a flat and substantially circular columnar three-dimensional shape. This helps to prevent what is called a dead space, more specifically, a gap between the outer package can 10 and the battery device 40, from easily resulting when the battery device 40 is placed inside the outer package can 10, as compared with when the battery device 40 has a three-dimensional shape different from the three-dimensional shape of the outer package can 10. This allows for efficient use of the internal space of the outer package can 10. As a result, the device space volume increases, and the energy density per unit volume of the secondary battery increases accordingly.

The positive electrode 41 is a first electrode to be used to cause the charging and discharging reactions to proceed. As illustrated in FIGS. 3 to 5, the positive electrode 41 includes a positive electrode current collector 41A, a positive electrode active material layer 41B, and a protective tape 41C. In addition, as illustrated in FIG. 4A, the positive electrode 41 has a substantially rectangular shape, in a plan view, in which the height direction Z corresponds to a transverse direction and a winding direction θ of the battery device 40 corresponds to a longitudinal direction. That is, the positive electrode 41 is a band-shaped member defined by an upper side edge 41UT, an inner winding side edge 41S, a lower side edge 41BT, and an outer winding side edge 41E. The upper side edge 41UT is positioned on an upper side in the height direction Z, and extends along the longitudinal direction (the winding direction θ). The inner winding side edge 41S is positioned on an innermost wind side in the winding direction θ, and extends along the height direction Z. The lower side edge 41BT is positioned on a lower side in the height direction Z, and extends along the longitudinal direction (the winding direction θ). The outer winding side edge 41E is positioned on an outermost wind side in the winding direction θ, and extends along the height direction Z.

The positive electrode current collector 41A has two opposed surfaces on each of which the positive electrode active material layer 41B is to be provided. More specifically, the positive electrode current collector 41A has an inner surface facing toward a winding center side of the battery device 40, that is, facing toward the position P0, and an outer surface facing toward an opposite side to the winding center side of the battery device 40, that is, positioned on an opposite side to the inner surface. The positive electrode current collector 41A includes an electrically conductive material such as a metal material. The positive electrode current collector 41A is a metal foil including aluminum or an aluminum alloy, for example.

The positive electrode active material layer 41B is provided on each of a portion of the inner surface of the positive electrode current collector 41A and a portion of the outer surface of the positive electrode current collector 41A, for example. Note that the positive electrode active material layer 41B may be provided only on one of the inner and outer surfaces of the positive electrode current collector 41A. The positive electrode active material layer 41B includes any one or more of positive electrode active materials into which lithium is insertable and from which lithium is extractable. The positive electrode active material layer 41B may further include other materials including, without limitation, a positive electrode binder and a positive electrode conductor. A method of forming the positive electrode active material layer 41B is not particularly limited, and specific examples thereof include a coating method.

The positive electrode 41 includes a positive electrode current collector covered region 411 and a positive electrode current collector exposed region 412. The positive electrode current collector covered region 411 is a region, of the positive electrode 41, in which the positive electrode current collector 41A is covered with the positive electrode active material layer 41B. The positive electrode current collector exposed region 412 is a region, of the positive electrode 41, other than the positive electrode current collector covered region 411. That is, the positive electrode current collector exposed region 412 is a region in which the positive electrode current collector 41A is exposed without being covered with the positive electrode active material layer 41B. As illustrated in FIG. 4A, the positive electrode current collector covered region 411 and the positive electrode current collector exposed region 412 each extend, along the height direction Z, i.e., the transverse direction of the positive electrode 41, from the upper side edge 41UT of the positive electrode 41 to the lower side edge 41BT of the positive electrode 41. In addition, two positive electrode current collector exposed regions 412 are provided at two respective ends of the positive electrode 41 in the winding direction θ, i.e., the longitudinal direction. One of the two positive electrode current collector exposed regions 412 includes the inner winding side edge 41S of the innermost positive electrode wind part 41in (FIG. 5) of the positive electrode 41, and another of the two positive electrode current collector exposed regions 412 includes the outer winding side edge 41E of the outermost positive electrode wind part 41out (FIG. 5) of the positive electrode 41. The positive electrode current collector covered region 411 is disposed to be sandwiched between the two positive electrode current collector exposed regions 412 in the winding direction θ. That is, the positive electrode active material layer 41B is present at neither of the two ends of the positive electrode current collector 41A in the winding direction θ, i.e., the longitudinal direction. The protective tape 41C is provided in a portion of the positive electrode current collector covered region 411. More specifically, the protective tape 41C covers a part, of the positive electrode current collector 41A in the positive electrode current collector exposed region 412, that is opposed to a negative electrode active material layer 42B (to be described later). The positive electrode lead 51 is attached to the positive electrode current collector 41A in the positive electrode current collector exposed region 412 positioned on an inner winding side. The positive electrode lead 51 is so provided that a portion of the positive electrode lead 51 protrudes above from the upper side edge 41UT of the positive electrode 41.

The positive electrode active material includes a lithium compound. The term “lithium compound” is a generic term for a compound that includes lithium as a constituent element. More specifically, the lithium compound is a compound that includes lithium and one or more transition metal elements as constituent elements. One reason for this is that a high energy density is obtainable. Note that the lithium compound may further include any one or more of other elements (excluding lithium and transition metal elements). Although not particularly limited in kind, the lithium compound is specifically an oxide, a phosphoric acid compound, a silicic acid compound, or a boric acid compound, for example. Specific examples of the oxide include LiNiO₂, LiCoO₂, and LiMn₂O₄. Specific examples of the phosphoric acid compound include LiFePO₄ and LiMnPO₄.

The positive electrode binder includes any one or more of materials including, without limitation, a synthetic rubber and a polymer compound. Examples of the synthetic rubber include a styrene-butadiene-based rubber. Examples of the polymer compound include polyvinylidene difluoride. The positive electrode conductor includes any one or more of electrically conductive materials including, without limitation, a carbon material. Examples of the carbon material include graphite, carbon black, acetylene black, and Ketjen black. The electrically conductive material may be a metal material or a polymer compound, for example.

The negative electrode 42 is a second electrode to be used to cause the charging and discharging reactions to proceed. As illustrated in FIGS. 3 to 5, the negative electrode 42 includes a negative electrode current collector 42A and the negative electrode active material layer 42B. In addition, as illustrated in FIG. 4B, the negative electrode 42 has a substantially rectangular shape, in a plan view, in which the height direction Z corresponds to a transverse direction and the winding direction θ of the battery device 40 corresponds to a longitudinal direction. That is, the negative electrode 42 is a band-shaped member defined by an upper side edge 42UT, an inner winding side edge 42S, a lower side edge 42BT, and an outer winding side edge 42E. The upper side edge 42UT is positioned on an upper side in the height direction Z, and extends along the longitudinal direction (the winding direction θ). The inner winding side edge 42S is positioned on the inner winding side in the winding direction θ, and extends along the height direction Z. The lower side edge 42BT is positioned on a lower side in the height direction Z, and extends along the longitudinal direction (the winding direction θ). The outer winding side edge 42E is positioned on an outer winding side in the winding direction θ, and extends along the height direction Z. The negative electrode 42 has a length H42 in the height direction Z.

The negative electrode current collector 42A has two opposed surfaces on each of which the negative electrode active material layer 42B is to be provided. More specifically, the negative electrode current collector 42A has an inner surface 42A1 facing toward the winding center side of the battery device 40, that is, facing toward the position P0, and an outer surface 42A2 facing toward the opposite side to the winding center side of the battery device 40, that is, positioned on an opposite side to the inner surface 42A1. The negative electrode current collector 42A is a metal foil including nickel, a nickel alloy, copper, or a copper alloy, for example.

The negative electrode active material layer 42B is provided on each of a portion of the inner surface of the negative electrode current collector 42A and a portion of the outer surface of the negative electrode current collector 42A, for example. The negative electrode active material layer 42B includes any one or more of negative electrode active materials into which lithium is insertable and from which lithium is extractable. The negative electrode active material layer 42B may further include other materials including, without limitation, a negative electrode binder and a negative electrode conductor. Details of the negative electrode binder are similar to the details of the positive electrode binder. Details of the negative electrode conductor are similar to the details of the positive electrode conductor. A method of forming the negative electrode active material layer 42B is not particularly limited, and specifically includes any one or more of methods including, without limitation, a coating method, a vapor-phase method, a liquid-phase method, a thermal spraying method, and a firing (sintering) method.

As illustrated in FIG. 4B, the negative electrode 42 includes a negative electrode current collector covered region 421 and a negative electrode current collector exposed region 422. The negative electrode current collector covered region 421 is a region, of the negative electrode 42, in which the negative electrode current collector 42A is covered with the negative electrode active material layer 42B. The negative electrode current collector exposed region 422 is a region, of the negative electrode 42, other than the negative electrode current collector covered region 421. That is, the negative electrode current collector exposed region 42 is a region in which the negative electrode current collector 42A is exposed without being covered with the negative electrode active material layer 42B. The negative electrode current collector covered region 421 and the negative electrode current collector exposed region 422 each extend, along the height direction Z, i.e., the transverse direction of the negative electrode 42, from the upper side edge 42UT of the negative electrode 42 to the lower side edge 42BT of the negative electrode 42. In addition, two negative electrode current collector exposed regions 422 are provided at two respective ends of the negative electrode 42 in the winding direction θ, i.e., the longitudinal direction. One of the two negative electrode current collector exposed regions 422 includes the inner winding side edge 42S of the innermost negative electrode wind part 42 in (FIG. 5) of the negative electrode 42, and another of the two negative electrode current collector exposed regions 422 includes the outer winding side edge 42E of the outermost negative electrode wind part 42out (FIG. 5) of the negative electrode 42. The negative electrode current collector covered region 421 is disposed to be sandwiched between the two negative electrode current collector exposed regions 422 in the winding direction θ. That is, the negative electrode active material layer 42B is present at neither of the two ends of the negative electrode current collector 42A in the winding direction θ, i.e., the longitudinal direction.

As illustrated in FIGS. 3 to 5, the negative electrode lead 52 is attached to the negative electrode current collector 42A in the negative electrode current collector exposed region 422. More specifically, the negative electrode lead 52 is attached to the inner surface 42A1 of the negative electrode current collector 42A in the negative electrode current collector exposed region 422 positioned on the outer winding side of the two negative electrode current collector exposed regions 422. As illustrated in FIG. 4B, the negative electrode lead 52 is so provided that a portion of the negative electrode lead 52 protrudes below from the lower side edge 42BT of the negative electrode 42. The negative electrode current collector 42A has a cutout 42K in a portion of the lower side edge 42BT. The cutout 42K has an outline curved in an arc, for example.

In addition, as illustrated in FIG. 4B, a length HWA in the height direction Z of a joining region WA, of the negative electrode current collector 42A, that includes a joined part WP to which the negative electrode lead 52 is joined is shorter than the length H42 in the height direction Z of the negative electrode current collector 42A in the negative electrode current collector covered region 421. That is, a spacing between the upper side edge 42UT and the lower side edge 42BT at a location where the negative electrode lead 52 is attached in the negative electrode current collector 42A is narrower than a spacing between the upper side edge 42UT and the lower side edge 42BT in the negative electrode current collector covered region 421 of the negative electrode current collector 42A.

As illustrated in FIGS. 4A, 4B, and 5, the protective tape 41C of the positive electrode 41 entirely covers a region, of the positive electrode current collector exposed region 412 of the positive electrode 41, that is opposed to the negative electrode current collector covered region 421 of the negative electrode 42 with the separator 43 interposed therebetween. The protective tape 41C makes it possible to effectively prevent an internal short circuit of the secondary battery when foreign matter enters between the negative electrode current collector covered region 421 and the positive electrode current collector exposed region 412, for example. Further, when the secondary battery undergoes an impact, the protective tape 41C absorbs the impact and thereby makes it possible to effectively prevent bending of the positive electrode current collector exposed region 412 and a short circuit between the positive electrode current collector exposed region 412 and the negative electrode 42. Further, even if a local rise in potential occurs in the positive electrode current collector covered region 411 in the vicinity of a boundary between the positive electrode current collector covered region 411 and the positive electrode current collector exposed region 412, the protective tape 41C makes it possible to suppress outflow of metal ions from the positive electrode active material layer 41B, and makes it possible to prevent a short circuit between the positive electrode 41 and the negative electrode 42.

The negative electrode active material includes a carbon material, a metal-based material, or both. One reason for this is that a high energy density is obtainable. Examples of the carbon material include graphitizable carbon, non-graphitizable carbon, and graphite (natural graphite and artificial graphite). The metal-based material is a material that includes, as one or more constituent elements, any one or more elements among metal elements and metalloid elements that are each able to form an alloy with lithium. Examples of such metal elements and metalloid elements include silicon, tin, or both. The metal-based material may be a simple substance, an alloy, a compound, a mixture of two or more thereof, or a material including two or more phases thereof. Specific examples of the metal-based material include TiSi₂ and SiOₓ (0<x≤2 or 0.2<x<1.4).

Here, the negative electrode 42 has a height greater than a height of the positive electrode 41. More specifically, as illustrated in FIG. 2, the upper side edge 42UT of the negative electrode 42 protrudes above the upper side edge 41UT of the positive electrode 41, and the lower side edge 42BT of the negative electrode 42 protrudes below the lower side edge 41BT of the positive electrode 41. One reason for this is to prevent precipitation of lithium extracted from the positive electrode 41. The “height” is a dimension corresponding to the height H of the secondary battery described above, that is, a dimension in the up-down direction in each of FIGS. 1 and 2, i.e., the height direction Z. The definition of the height described here applies also to the following.

The separator 43 is an insulating porous film disposed between the positive electrode 41 and the negative electrode 42, as illustrated in FIGS. 2 and 3. The separator 43 allows lithium ions to pass through the separator 43 and prevents a short circuit between the positive electrode 41 and the negative electrode 42. The separator 43 includes a polymer compound such as polyethylene. Here, the separator 43 has a height greater than the height of the negative electrode 42, as illustrated in FIG. 2. More specifically, the separator 43 preferably protrudes above the upper side edge 42UT of the negative electrode 42 and protrudes below the lower side edge 42BT of the negative electrode 42.

The electrolytic solution includes a solvent and an electrolyte salt. The positive electrode 41, the negative electrode 42, and the separator 43 are each impregnated with the electrolytic solution. The solvent includes any one or more of non-aqueous solvents (organic solvents) including, without limitation, a carbonic-acid-ester-based compound, a carboxylic-acid-ester-based compound, and a lactone-based compound. An electrolytic solution that includes any of the non-aqueous solvents is what is called a non-aqueous electrolytic solution. The electrolyte salt includes any one or more of light metal salts including, without limitation, a lithium salt.

As illustrated in FIG. 2, the positive electrode lead 51 is contained inside the outer package can 10. The positive electrode lead 51 is a coupling wiring coupled to each of the positive electrode 41 and the external terminal 20. The secondary battery illustrated in FIG. 2 includes one positive electrode lead 51. However, the secondary battery may include two or more positive electrode leads 51.

The positive electrode lead 51 is coupled to the positive electrode current collector 41A in the positive electrode current collector exposed region 412, as described above. Further, the positive electrode lead 51 is coupled to a portion of the surface 20S of the external terminal 20 through the through hole 12K provided in the cover part 12. A method of coupling the positive electrode lead 51 is not particularly limited, and specifically includes any one or more of welding methods including, without limitation, a resistance welding method and a laser welding method. The details of the welding methods described here apply also to the following.

A portion of the positive electrode lead 51 is electrically insulated from each of the cover part 12 of the outer package can 10 and the negative electrode 42 of the battery device 40, and is sandwiched by the cover part 12 and the battery device 40 in the height direction of the secondary battery. As illustrated in FIG. 2, the positive electrode lead 51 includes a first part 511, a second part 512, and a turning part 513. The first part 511 and the second part 512 each extend along a horizontal plane orthogonal to the height direction Z of the secondary battery. Further, the first part 511 and the second part 512 overlap each other in the height direction Z of the secondary battery, with the sealant 61 interposed between the first part 511 and the second part 512. The turning part 513 is so curved as to couple the first part 511 and the second part 512 to each other. The first part 511 and the second part 512 are sandwiched between the battery device 40 and the recessed part 12H of the cover part 12 in the height direction Z of the secondary battery.

As described above, a portion of the positive electrode lead 51 is held by the cover part 12 and the battery device 40 by extending along each of a lower surface of the cover part 12 and an upper surface of the battery device 40. This allows the positive electrode lead 51 to be fixed inside the outer package can 10. By preventing the positive electrode lead 51 from easily moving even if the secondary battery undergoes external force such as a vibration or an impact, the positive electrode lead 51 is prevented from being easily damaged. Here, examples of damage to the positive electrode lead 51 include cracking of the positive electrode lead 51, breakage of the positive electrode lead 51, and detachment of the positive electrode lead 51 from the positive electrode 41.

More specifically, the wording “a portion of the positive electrode lead 51 is sandwiched by the outer package can 10 and the battery device 40” means that the positive electrode lead 51 is held by the outer package can 10 and the battery device 40 from above and below while being insulated from each of the outer package can 10 and the battery device 40, and that the positive electrode lead 51 is thus in a state of being not easily movable inside the outer package can 10 even if the secondary battery undergoes external force such as a vibration or an impact. The state where the positive electrode lead 51 is not easily movable inside the outer package can 10 exactly indicates that the battery device 40 is also in the state of being not easily movable inside the outer package can 10. This also makes it possible to avoid a defect of the battery device 40, i.e., the wound electrode body, such as winding deformation, when the secondary battery undergoes, for example, a vibration or an impact.

As described above, the cover part 12 includes the recessed part 12H, and a portion of the positive electrode lead 51 is sandwiched by the recessed part 12H and the battery device 40. More specifically, the portion of the positive electrode lead 51 is held by the recessed part 12H and the battery device 40 by extending along each of a lower surface of the recessed part 12H and the upper surface of the battery device 40. The recessed part 12H helps to hold the positive electrode lead 51 more easily. This helps to further prevent the positive electrode lead 51 from being easily damaged.

Further, a portion of the positive electrode lead 51 is insulated from the cover part 12 and the negative electrode 42 via each of the separator 43, the sealant 61, and the insulating films 62 and 63.

Specifically, as described above, the height of the separator 43 is greater than the height of the negative electrode 42. Accordingly, a portion of the positive electrode lead 51 is separated from the negative electrode 42 by the separator 43, and is thus insulated from the negative electrode 42 via the separator 43. One reason for this is to prevent a short circuit between the positive electrode lead 51 and the negative electrode 42.

Further, the positive electrode lead 51 is covered at a periphery thereof by the sealant 61 having an insulating property. A portion of the positive electrode lead 51 is thus insulated from each of the cover part 12 and the negative electrode 42 via the sealant 61. One reason for this is to prevent a short circuit between the positive electrode lead 51 and the cover part 12, and to also prevent a short circuit between the positive electrode lead 51 and the negative electrode 42.

Further, the insulating film 62 is disposed between the cover part 12 and the positive electrode lead 51. A portion of the positive electrode lead 51 is thus insulated from the cover part 12 via the insulating film 62. One reason for this is to prevent a short circuit between the positive electrode lead 51 and the cover part 12.

Furthermore, the insulating film 63 is disposed between the battery device 40 and the positive electrode lead 51. A portion of the positive electrode lead 51 is thus insulated from the negative electrode 42 via the insulating film 63. One reason for this is to prevent a short circuit between the positive electrode lead 51 and the negative electrode 42.

Details of a material included in the positive electrode lead 51 are similar to the details of the material included in the positive electrode current collector 41A. Note that the material included in the positive electrode lead 51 and the material included in the positive electrode current collector 41A may be the same as or different from each other.

A position of coupling of the positive electrode lead 51 to the positive electrode 41 is not particularly limited, and may be chosen as desired. In particular, the positive electrode lead 51 is preferably coupled to the positive electrode 41 on an inner side of winding of the positive electrode 41 relative to the outermost wind of the positive electrode 41. One reason for this is that corrosion of the outer package can 10 caused by creeping up of the electrolytic solution is suppressed unlike when the positive electrode lead 51 is coupled to the positive electrode 41 in the outermost wind of the positive electrode 41. The “creeping up of the electrolytic solution” refers to a phenomenon in which, when the positive electrode lead 51 is disposed in proximity to an inner wall surface of the outer package can 10, the electrolytic solution in the battery device 40 creeps up along the positive electrode lead 51 to reach the inner wall surface of the outer package can 10. The electrolytic solution coming into contact with the outer package can 10 as a result of the “creeping up of the electrolytic solution” causes a phenomenon in which the outer package can 10 dissolves or changes in color.

Note that the positive electrode lead 51 is provided separately from the positive electrode current collector 41A. However, the positive electrode lead 51 may be physically continuous with the positive electrode current collector 41A and may thus be provided integrally with the positive electrode current collector 41A.

As illustrated in FIG. 2, the negative electrode lead 52 is contained inside the outer package can 10. The negative electrode lead 52 electrically couples the negative electrode 42 and the outer package can 10 (the container part 11) to each other. Accordingly, the container part 11 (the bottom part M2) is electrically coupled to the negative electrode 42 via the negative electrode lead 52. Here, the secondary battery includes one negative electrode lead 52. However, the secondary battery may include two or more negative electrode leads 52. Note that the negative electrode lead 52 corresponds to a specific example of a “lead” in the present disclosure.

As described above, the negative electrode lead 52 is so coupled to the negative electrode current collector 42A as to protrude from the lower side edge 42BT of the negative electrode 42. Further, the negative electrode lead 52 is coupled to a bottom surface of the container part 11. A method of coupling the negative electrode lead 52 is not particularly limited, and specifically includes any one or more of welding methods including, without limitation, the resistance welding method and the laser welding method.

Details of a material included in the negative electrode lead 52 are similar to the details of the material included in the negative electrode current collector 42A. Note that the material included in the negative electrode lead 52 and the material included in the negative electrode current collector 42A may be the same as or different from each other. Examples of the material included in the negative electrode lead 52 include nickel.

A position of coupling of the negative electrode lead 52 to the negative electrode 42 is not particularly limited, and may be chosen as desired. Here, the negative electrode lead 52 is coupled to an outermost wind portion of the negative electrode 42 included in the wound electrode body.

Note that the negative electrode lead 52 is provided separately from the negative electrode current collector 42A. However, the negative electrode lead 52 may be physically continuous with the negative electrode current collector 42A and may thus be provided integrally with the negative electrode current collector 42A.

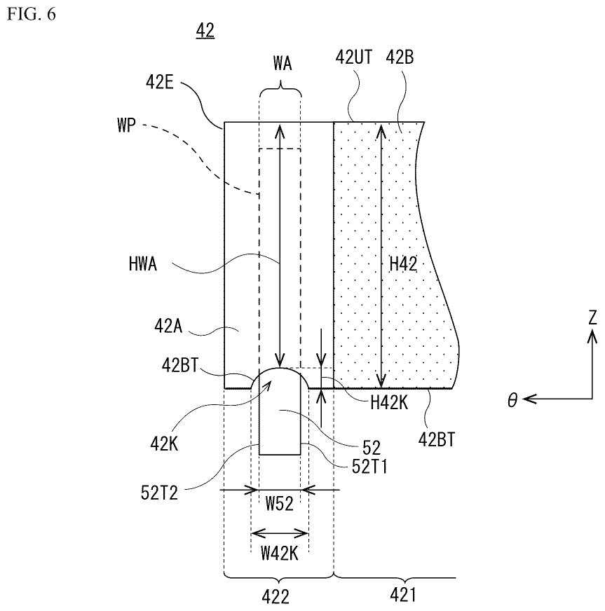

FIG. 6 is an enlarged plan view of the negative electrode lead 52 and the vicinity thereof illustrated in FIG. 4B. The negative electrode lead 52 includes two opposed edges 52T1 and 52T2 that are two opposed edges in a width direction (the winding direction θ), of the negative electrode lead 52, orthogonal to an extending direction (the height direction Z) of the negative electrode lead 52. As described above, the negative electrode current collector 42A has the cutout 42K, and the negative electrode lead 52 is so joined to the negative electrode current collector 42A as to overlap the cutout 42K in the radial direction R. Accordingly, the negative electrode lead 52 is joined to the negative electrode current collector 42A in a state where the two opposed edges 52T1 and 52T2 are inclined relative to the lower side edge 42BT. As used herein, the wording “a state where the two opposed edges 52T1 and 52T2 are inclined relative to the lower side edge 42BT” means that an angle at which the lower side edge 42BT and the edge 52T1 intersect, and an angle at which the lower side edge 42BT and the edge 52T2 intersect are each other than 90°. In addition, a length W42K in the winding direction θ of the cutout 42K of the negative electrode current collector 42A is preferably longer than a length W52 in the winding direction θ of the negative electrode lead 52. Note that, in the configuration example illustrated in FIG. 6, the length W42K in the winding direction θ of the cutout 42K is longer than a length H42K in the height direction Z of the cutout 42K. A portion, of the negative electrode lead 52, that is joined to the negative electrode current collector 42A extends in the height direction Z, for example. However, a portion, of the negative electrode lead 52, that protrudes below from the lower side edge 42BT is bent along a horizontal plane orthogonal to the height direction Z, as illustrated in FIG. 2. The presence of the cutout 42K at the lower side edge 42BT of the negative electrode current collector 42A reduces stress to be applied to the lower side edge 42BT by the negative electrode lead 52 being bent.

The sealant 61 is a first insulating member covering the periphery of the positive electrode lead 51, as illustrated in FIG. 2. The sealant 61 includes two insulating tapes each being attached to corresponding one of a front surface and a back surface of the positive electrode lead 51. Here, in order to allow the positive electrode lead 51 to be coupled to each of the positive electrode 41 and the external terminal 20, the sealant 61 covers the periphery of a portion in the middle of the positive electrode lead 51. Note that a structure of the sealant 61 is not limited to a tape-shaped structure, and the sealant 61 may have a tube-shaped structure, for example.

The sealant 61 includes any one or more of insulating materials including, without limitation, a polymer compound having an insulating property. Examples of the insulating materials include polyimide.

The insulating film 62 is an insulating member disposed between the cover part 12 and the battery device 40 in the height direction Z, as illustrated in FIG. 2. Here, the insulating film 62 is ring-shaped in a plan view and has an opening 62K at a location corresponding to the through hole 12K in the height direction Z.

Here, the insulating film 62 may be adhered to the cover part 12 with an adhesive layer interposed therebetween.

The insulating film 62 may include any one or more of insulating materials including, without limitation, a polymer compound having an insulating property. Examples of the insulating materials to be included in the insulating film 62 include polyimide.

The insulating film 63 is an insulating member disposed between the battery device 40 and the positive electrode lead 51, as illustrated in FIG. 2. Here, the insulating film 63 is flat plate-shaped in a plan view. The insulating film 63 is disposed to block the winding center space 40K and to cover the battery device 40 around the winding center space 40K.

Details of a material included in the insulating film 63 are similar to the details of the material included in the insulating film 62. Note that the material included in the insulating film 63 and the material included in the insulating film 62 may be the same as or different from each other.

Note that the secondary battery may further include one or more other components according to an embodiment.

For example, the secondary battery includes a safety valve mechanism. The safety valve mechanism is to cut off electrical coupling between the outer package can 10 and the battery device 40 if an internal pressure of the outer package can 10 reaches a certain level or higher. Examples of a factor that causes the internal pressure of the outer package can 10 to reach the certain level or higher include occurrence of a short circuit in the secondary battery and heating of the secondary battery from outside. Although a placement location of the safety valve mechanism is not particularly limited, the safety valve mechanism is preferably placed on either the bottom part M1 or the bottom part M2, and more preferably, on the bottom part M2 to which no external terminal 20 is attached, in particular.

Further, the secondary battery may include an insulator, other than the insulating films 62 and 64, between the outer package can 10 and the battery device 40. The insulator includes any one or more of materials including, without limitation, an insulating film and an insulating sheet, and prevents a short circuit between the outer package can 10 and the battery device 40. A range of placement of the insulator is not particularly limited, and may be chosen as desired.

Note that the outer package can 10 is provided with a cleavage valve. The cleavage valve cleaves to release the internal pressure of the outer package can 10 when the internal pressure reaches a certain level or higher. A placement location of the cleavage valve is not particularly limited. However, the cleavage valve is preferably placed on either the bottom part M1 or the bottom part M2, and more preferably, on the bottom part M2, in particular, as with the placement location of the safety valve mechanism described above.

Upon charging of the secondary battery, in the battery device 40, lithium is extracted from the positive electrode 41, and the extracted lithium is inserted into the negative electrode 42 through the electrolytic solution. Upon discharging of the secondary battery, in the battery device 40, lithium is extracted from the negative electrode 42, and the extracted lithium is inserted into the positive electrode 41 through the electrolytic solution. Upon the charging and the discharging, lithium is inserted and extracted in an ionic state.

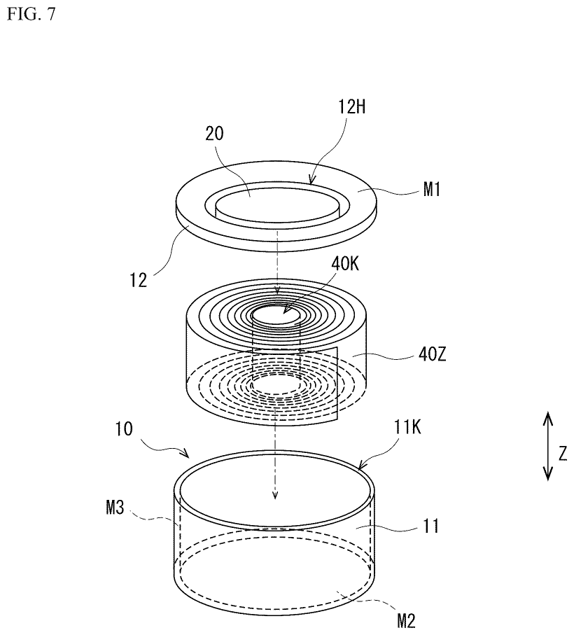

FIG. 7 illustrates a perspective configuration of the outer package can 10 to be used in the process of manufacturing the secondary battery, and corresponds to FIG. 1.

FIG. 7 illustrates a state where the cover part 12 is separate from the container part 11 before the cover part 12 is welded to the container part 11.

In the following description, where appropriate, FIGS. 1 to 6 described already will be referred to together with FIG. 7.

Here, as illustrated in FIG. 7, the container part 11 and the cover part 12 that are physically separate from each other are prepared to form the outer package can 10. The container part 11 is a substantially bowl-shaped member in which the bottom part M2 and the sidewall part M3 are integrated with each other, and has the opening 11K. The cover part 12 is a substantially plate-shaped member corresponding to the bottom part M1. The external terminal 20 is attached in advance to the recessed part 12H provided in the cover part 12, with the gasket 30 interposed between the external terminal 20 and the recessed part 12H.

Alternatively, the bottom part M2 and the sidewall part M3 that are physically separate from each other may be prepared and the container part 11 may be formed by welding the sidewall part M3 to the bottom part M2.

First, the positive electrode active material and other materials including, without limitation, the positive electrode binder and the positive electrode conductor are mixed with each other to thereby make a positive electrode mixture. Thereafter, the positive electrode mixture thus made is put into a solvent such as an organic solvent to thereby prepare a positive electrode mixture slurry in paste form. Thereafter, the positive electrode mixture slurry is applied on the two opposed surfaces of the positive electrode current collector 41A to thereby form the positive electrode active material layers 41B. Lastly, the positive electrode active material layers 41B are compression-molded by, for example, a roll pressing machine. In this case, the positive electrode active material layers 41B may be heated. The positive electrode active material layers 41B may be compression-molded multiple times. The positive electrode 41 is thus fabricated.

The negative electrode 42 is fabricated by a procedure similar to the fabrication procedure of the positive electrode 41. Specifically, a negative electrode mixture, which is obtained by mixing the negative electrode active material and other materials including, without limitation, the negative electrode binder and the negative electrode conductor with each other, is put into an organic solvent to thereby prepare a negative electrode mixture slurry in paste form, following which the negative electrode mixture slurry is applied on the two opposed surfaces of the negative electrode current collector 42A to thereby form the negative electrode active material layers 42B. Thereafter, the negative electrode active material layers 42B are compression-molded by, for example, a roll pressing machine. The negative electrode 42 is thus fabricated.

The electrolyte salt is put into the solvent. The electrolyte salt is thereby dispersed or dissolved in the solvent. The electrolytic solution is thus prepared.

First, the positive electrode lead 51 covered at the periphery thereof by the sealant 61 is coupled to the positive electrode 41 (the positive electrode current collector 41A) by a welding method such as the resistance welding method, and the negative electrode lead 52 is coupled to the negative electrode 42 (the negative electrode current collector 42A) by a welding method such as the resistance welding method.

Thereafter, the positive electrode 41 and the negative electrode 42 are stacked on each other with the separator 43 interposed therebetween, following which the stack including the positive electrode 41, the negative electrode 42, and the separator 43 is wound to thereby fabricate a wound body 40Z, as illustrated in FIG. 7. The wound body 40Z has a configuration similar to that of the battery device 40 except that the positive electrode 41, the negative electrode 42, and the separator 43 are each unimpregnated with the electrolytic solution. Note that FIG. 7 omits the illustration of each of the positive electrode lead 51 and the negative electrode lead 52.

Thereafter, the wound body 40Z to which the positive electrode lead 51 and the negative electrode lead 52 are each coupled is placed into the container part 11 through the opening 11K. In this case, the negative electrode lead 52 is coupled to the container part 11 by a welding method such as the resistance welding method. Thereafter, the insulating film 63 is placed on the wound body 40Z.

Thereafter, the cover part 12 to which the external terminal 20 is attached in advance with the gasket 30 interposed therebetween and on which the insulating film 62 is provided in advance is prepared, following which the positive electrode lead 51 is coupled to the external terminal 20 through the through hole 12K by a welding method such as the resistance welding method.

As a result, the wound body 40Z (the positive electrode 41) contained inside the container part 11 and the external terminal 20 attached to the cover part 12 are coupled to each other via the positive electrode lead 51.

Thereafter, the electrolytic solution is injected into the container part 11 through the opening 11K. In this case, because the opening 11K is not closed by the cover part 12 as described above, the electrolytic solution is easily injectable into the container part 11 through the opening 11K even if the battery device 40 and the external terminal 20 are coupled to each other via the positive electrode lead 51. The wound body 40Z including the positive electrode 41, the negative electrode 42, and the separator 43 is thereby impregnated with the electrolytic solution. The battery device 40 that is the wound electrode body is thus fabricated.

Thereafter, the cover part 12 is brought down into close proximity to the container part 11 to thereby close the opening 11K with the cover part 12, following which the cover part 12 is welded to the container part 11 by a welding method such as the laser welding method. In this case, as illustrated in FIG. 2, a portion of the positive electrode lead 51 is caused to be sandwiched between the cover part 12 and the battery device 40, and the turning part 513 that is curved is formed on a front side relative to the location where the positive electrode lead 51 is coupled to the external terminal 20. In this manner, the outer package can 10 is formed, and the battery device 40 and other components are contained inside the outer package can 10. Assembly of the secondary battery is thus completed.

The secondary battery after being assembled is charged and discharged. Various conditions including, for example, an environment temperature, the number of times of charging and discharging (the number of cycles), and charging and discharging conditions, may be chosen as desired. As a result, a film is formed on a surface of, for example, the negative electrode 42. This brings the secondary battery into an electrochemically stable state. The secondary battery is thus completed.

As described above, in the secondary battery according to the present embodiment, in the negative electrode 42 of the battery device 40, the negative electrode lead 52 is joined to the negative electrode current collector 42A in the state where the two opposed edges 52T1 and 52T2 are inclined relative to the lower side edge 42BT. Specifically, the negative electrode current collector 42A has the cutout 42K in a portion of the lower side edge 42BT, and the negative electrode lead 52 is joined to the negative electrode current collector 42A at a location that overlaps the cutout 42K. This makes it possible to reduce a decrease in strength of the negative electrode current collector 42A and to avoid cracking and breakage of a first electrode current collector. One reason for this is that stress to be applied to the negative electrode current collector 42A by the negative electrode lead 52 is reduced even in a state where the negative electrode lead 52 is bent.

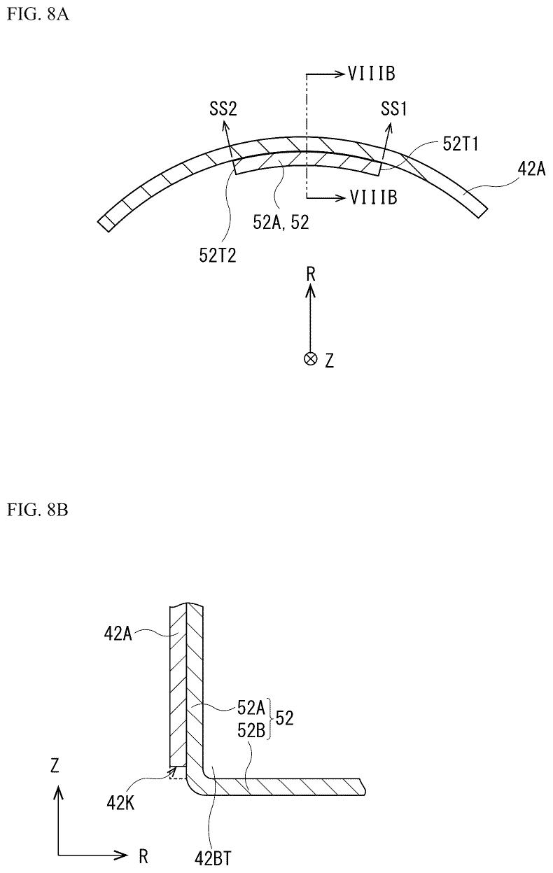

The action and effects of the secondary battery according to the present embodiment will be described in more detail with reference to FIGS. 8A and 8B. FIG. 8A is a partial enlarged sectional diagram illustrating, in an enlarged manner, a portion of the battery device 40 illustrated in FIG. 5. FIG. 8B is a partial enlarged sectional diagram illustrating, in an enlarged manner, a portion of the battery device 40 illustrated in FIG. 2. FIG. 8B illustrates a section as viewed in an arrowed direction along line VIII-VIII illustrated in FIG. 8A.

For example, as illustrated in FIG. 8A, a joined part 52A, of the negative electrode lead 52, that is joined to the negative electrode current collector 42A is curved along a shape of the negative electrode current collector 42A wound around the center line PC as the winding axis, in a horizontal section orthogonal to the height direction Z. As illustrated in FIG. 8B, in the vicinity of the lower side edge 42BT of the negative electrode current collector 42A to which the negative electrode lead 52 is attached, a leading part 52B, of the negative electrode lead 52, that protrudes from the lower side edge 42BT is bent at a substantially right angle relative to the joined part 52A that is joined to the negative electrode current collector 42A. That is, while the joined part 52A extends in the height direction Z, the leading part 52B extends in the radial direction R. Accordingly, in particular, a portion, of the leading part 52B, in the vicinity of the lower side edge 42BT is to deform to be straight. The two opposed edges 52T1 and 52T2 of the leading part 52B of the negative electrode lead 52 are thus to apply stress to the negative electrode current collector 42A in directions indicated by arrows SS1 and SS2 in FIG. 8A. This causes compression stress and tensile stress to be locally applied to the negative electrode current collector 42A in the vicinity of the lower side edge 42BT. To address this, in the secondary battery according to the present embodiment, the cutout 42K is provided, and the negative electrode lead 52 is joined to the negative electrode current collector 42A in the state where the two opposed edges 52T1 and 52T2 are inclined relative to the lower side edge 42BT. The compression stress and the tensile stress described above to be applied to the lower side edge 42BT are thereby dispersed around the lower side edge 42BT to avoid stress concentration at the lower side edge 42BT. As a result, the negative electrode current collector 42A maintains sufficient strength, which makes it possible for the secondary battery according to the present embodiment to achieve high reliability.

In contrast, when the two opposed edges 52T1 and 52T2 are orthogonal to the lower side edge 42BT, unlike the secondary battery according to the present embodiment, stress easily concentrates at each of a position where the lower side edge 42BT and the edge 52T1 are in contact with each other and a position where the lower side edge 42BT and the edge 52T1 are in contact with each other. Accordingly, as compared with the secondary battery according to the present embodiment, there is a concern that the strength of the negative electrode current collector decreases.

In addition, in the secondary battery according to the present embodiment, the negative electrode lead 52 is joined to the inner surface 42A1 of the negative electrode current collector 42A. Accordingly, when the negative electrode lead 52 is present in an outermost wind portion of the negative electrode current collector 42A, insertability to the container part 11 of the outer package can 10 improves, as compared with when the negative electrode lead 52 is joined to the outer surface 42A2 of the negative electrode current collector 42A.

Further, the secondary battery may be a lithium-ion secondary battery. In such a case, it is possible to stably obtain a sufficient battery capacity through the use of insertion and extraction of lithium.

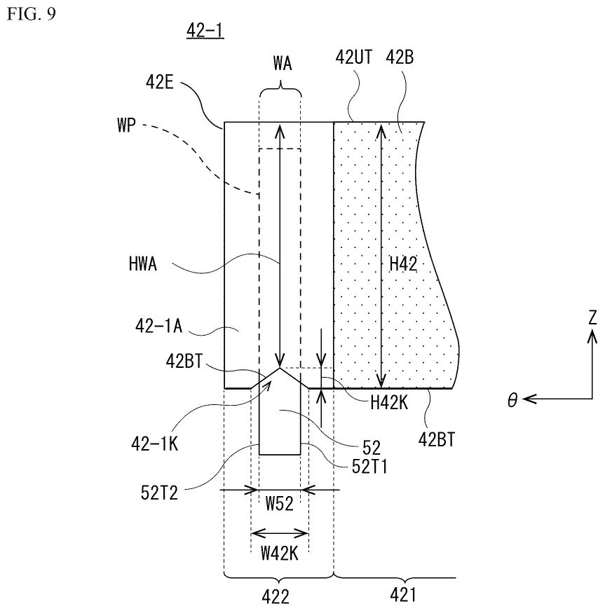

A description is given next of a negative electrode 42-1 as a first modification example of an embodiment of the present disclosure with reference to FIG. 9. FIG. 9 is an enlarged plan view of a portion of the negative electrode 42-1 as the first modification example, and corresponds to FIG. 6 that illustrates, in an enlarged manner, a portion of the negative electrode 42 of an embodiment described above. A negative electrode current collector 42-1A of the negative electrode 42-1 has a cutout 42-1K at the lower side edge 42BT of the negative electrode current collector exposed region 422. The cutout 42-1K has a substantially triangular shape having two straight line parts in a plan view. Except for those described above, a configuration of the negative electrode 42-1 as the first modification example is substantially the same as the configuration of the negative electrode 42 of an embodiment described above. The secondary battery including the negative electrode 42-1 of the first modification example is expected to achieve effects similar to those of the secondary battery including the negative electrode 42 of an embodiment described above.

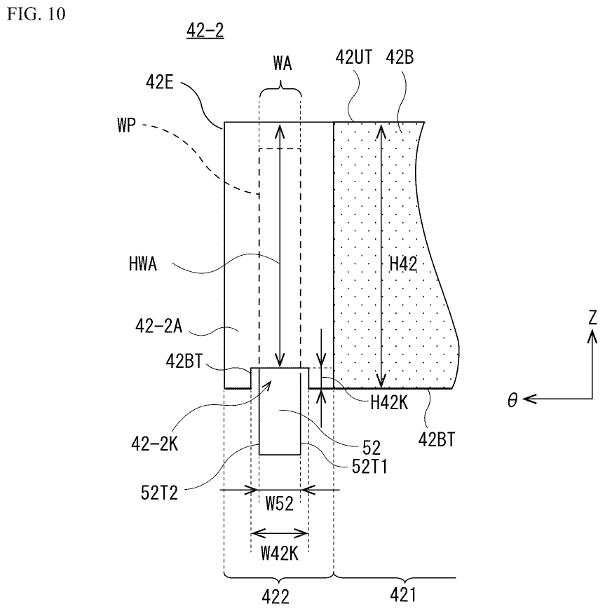

A description is given next of a negative electrode 42-2 as a second modification example of an embodiment of the present disclosure with reference to FIG. 10. FIG. 10 is an enlarged plan view of a portion of the negative electrode 42-2 as the second modification example, and corresponds to FIG. 6 that illustrates, in an enlarged manner, a portion of the negative electrode 42 of an embodiment described above. A negative electrode current collector 42-2A of the negative electrode 42-2 has a cutout 42-2K at the lower side edge 42BT of the negative electrode current collector exposed region 422. The cutout 42-2K has a substantially rectangular shape having three straight line parts in a plan view. Except for those described above, a configuration of the negative electrode 42-2 as the second modification example is substantially the same as the configuration of the negative electrode 42 of an embodiment described above. The secondary battery including the negative electrode 42-2 of the present modification example is expected to achieve effects similar to those of the secondary battery including the negative electrode 42 of an embodiment described above.

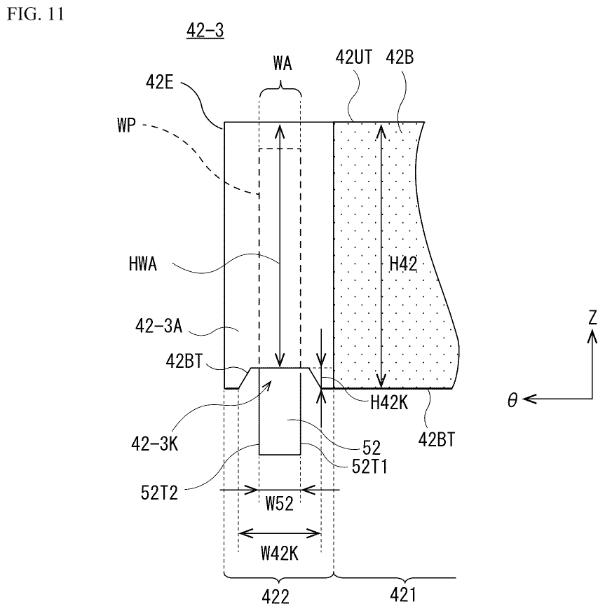

A description is given next of a negative electrode 42-3 as a third modification example of an embodiment of the present disclosure with reference to FIG. 11. FIG. 11 is an enlarged plan view of a portion of the negative electrode 42-3 as the third modification example, and corresponds to FIG. 6 that illustrates, in an enlarged manner, a portion of the negative electrode 42 in an embodiment described above. A negative electrode current collector 42-3A of the negative electrode 42-3 has a cutout 42-3K at the lower side edge 42BT of the negative electrode current collector exposed region 422. The cutout 42-3K has a substantially trapezoidal shape having three straight line parts in a plan view. Except for those described above, a configuration of the negative electrode 42-3 as the third modification example is substantially the same as the configuration of the negative electrode 42 of an embodiment described above. The secondary battery including the negative electrode 42-3 of the present modification example is expected to achieve effects similar to those of the secondary battery including the negative electrode 42 of an embodiment described above.

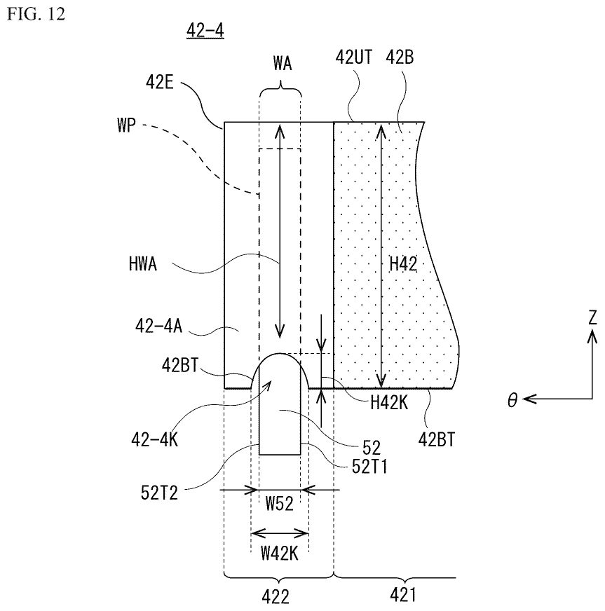

A description is given next of a negative electrode 42-4 as a fourth modification example of an embodiment of the present disclosure with reference to FIG. 12. FIG. 12 is an enlarged plan view of a portion of the negative electrode 42-4 as the fourth modification example, and corresponds to FIG. 6 that illustrates, in an enlarged manner, a portion of the negative electrode 42 in an embodiment described above. A negative electrode current collector 42-4A of the negative electrode 42-4 has a cutout 42-4K at the lower side edge 42BT of the negative electrode current collector exposed region 422. The cutout 42-4K has a semi-elliptical shape having a curved part in a plan view. The length H42K of the cutout 42-4K is longer than a half of the length W42K. Note that the length H42K may be equal to the half of the length W42K. Except for those described above, a configuration of the negative electrode 42-4 as the fourth modification example is substantially the same as the configuration of the negative electrode 42 of an embodiment described above. The secondary battery including the negative electrode 42-4 of the present modification example is expected to achieve effects similar to those of the secondary battery including the negative electrode 42 of an embodiment described above.

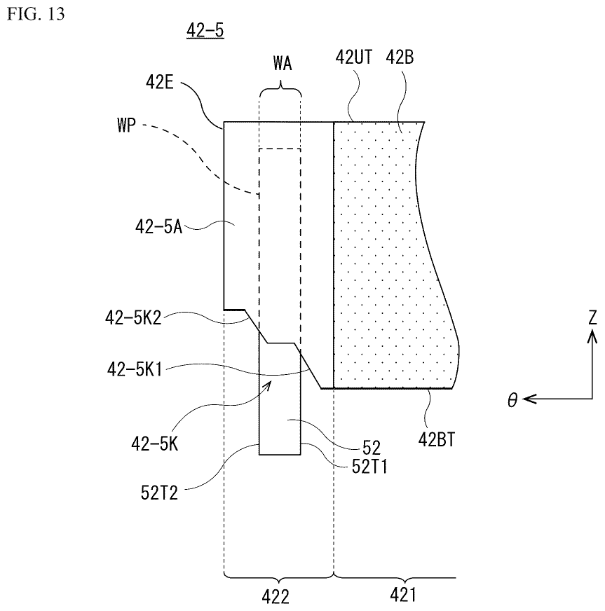

A description is given next of a negative electrode 42-5 as a fifth modification example of an embodiment of the present disclosure with reference to FIG. 13. FIG. 13 is an enlarged plan view of a portion of the negative electrode 42-5 as the fifth modification example, and corresponds to FIG. 6 that illustrates, in an enlarged manner, a portion of the negative electrode 42 in an embodiment described above. A negative electrode current collector 42-5A of the negative electrode 42-5 has a stepped cutout 42-5K at the lower side edge 42BT of the negative electrode current collector exposed region 422. The cutout 42-5K includes an inclined part 42-5K1 and an inclined part 42-5K2 respectively at a location intersecting the edge 52T1 of the negative electrode lead 52 and a location intersecting the edge 52T2 of the negative electrode lead 52. Except for those described above, a configuration of the negative electrode 42-5 as the fifth modification example is substantially the same as the configuration of the negative electrode 42 of an embodiment described above. The secondary battery including the negative electrode 42-5 of the present modification example is expected to achieve effects similar to those of the secondary battery including the negative electrode 42 of an embodiment described above.

### EXAMPLES

A description is given of Examples of the present disclosure according to an embodiment.

### Example 1

A hundred secondary batteries (lithium-ion secondary batteries) illustrated in FIGS. 1 to 6 were fabricated. Specifically, secondary batteries of a coin type that each included the negative electrode 42 having the cutout 42K were fabricated as described below.

### [Fabrication of Positive Electrode]

First, 91 parts by mass of a positive electrode active material (LiCoO₂), 3 parts by mass of a positive electrode binder (polyvinylidene difluoride), and 6 parts by mass of a positive electrode conductor (graphite) were mixed with each other to thereby obtain a positive electrode mixture. Thereafter, the positive electrode mixture was put into an organic solvent (N-methyl-2-pyrrolidone), following which the organic solvent was stirred to thereby prepare a positive electrode mixture slurry in paste form. Thereafter, the positive electrode mixture slurry was applied on the two opposed surfaces of the positive electrode current collector 41A (a band-shaped aluminum foil having a thickness of 12 μm) by a coating apparatus, following which the applied positive electrode mixture slurry was dried to thereby form the positive electrode active material layers 41B. Lastly, the positive electrode active material layers 41B were compression-molded by a roll pressing machine. In this manner, the positive electrode 41 (having a width of 3.3 mm) was fabricated. Note that a thickness of an inner side positive electrode active material layer 41B1 and a thickness of an outer side positive electrode active material layer 41B2 after the compression-molding were each set to 0.037 mm.

### [Fabrication of Negative Electrode]

First, 95 parts by mass of a negative electrode active material (graphite) and 5 parts by mass of a negative electrode binder (polyvinylidene difluoride) were mixed with each other to thereby obtain a negative electrode mixture. Thereafter, the negative electrode mixture was put into an organic solvent (N-methyl-2-pyrrolidone), following which the organic solvent was stirred to thereby prepare a negative electrode mixture slurry in paste form. Thereafter, a band-shaped copper foil having a thickness of 15 μm was prepared, and a portion of an outer edge of the copper foil was punched out to thereby form the cutout 42K. Thus, the negative electrode current collector 42A was fabricated. Thereafter, the positive electrode mixture slurry was applied on the two opposed surfaces of the negative electrode current collector 42A by a coating apparatus, following which the applied negative electrode mixture slurry was dried to thereby form the negative electrode active material layers 42B. Lastly, the negative electrode active material layers 42B were compression-molded by a roll pressing machine. In this manner, the negative electrode 42 (having a width of 3.8 mm) was fabricated.

### [Preparation of Electrolytic Solution]

An electrolyte salt (LiPF₆) was added to a solvent (ethylene carbonate and diethyl carbonate), following which the solvent was stirred. In this case, a mixture ratio (a weight ratio) between ethylene carbonate and diethyl carbonate in the solvent was set to 30:70, and a content of the electrolyte salt was set to 1 mol/kg with respect to the solvent. The electrolyte salt was thereby dissolved or dispersed in the solvent. As a result, the electrolytic solution was prepared.

### [Assembly of Secondary Battery]

First, the positive electrode lead 51 including aluminum was welded to the positive electrode 41 (the positive electrode current collector 41A) by the resistance welding method. The positive electrode lead 51 had a thickness of 0.1 mm, a width of 2.0 mm, and a protruding length of 11.7 mm from the positive electrode 41, and was partially covered at the periphery thereof by the sealant 61 having a tubular shape. The sealant 61 was a polypropylene film and had an outer diameter of 9.0 mm and an inner diameter of 3.0 mm. Further, the negative electrode lead 52 including nickel was welded to the negative electrode 42 (the negative electrode current collector 42A) by the resistance welding method. The negative electrode lead 52 had a thickness of 0.1 mm, a width of 2.0 mm, and a protruding length of 6.0 mm from the negative electrode 42.

Thereafter, the positive electrode 41 and the negative electrode 42 were stacked on each other with the separator 43 (a fine-porous polyethylene film having a thickness of 25 μm and a width of 4.0 mm) interposed therebetween. Thereafter, the stack of the positive electrode 41, the negative electrode 42, and the separator 43 was wound to thereby fabricate the wound body 40Z having a cylindrical shape. The wound body 40Z had an outer diameter of 11.6 mm. The wound body 40Z had the winding center space 40K. The winding center space 40K had an inner diameter of 1.5 mm.

Thereafter, a ring-shaped insulating film for underlayment was placed into the container part 11 through the opening 11K. The ring-shaped insulating film was a polyimide film and had an outer diameter of 11.6 mm, an inner diameter of 2.2 mm, and a thickness of 0.05 mm. The container part 11 had a cylindrical shape and included stainless steel (SUS316). The container part 11 had a wall thickness of 0.15 mm, an outer diameter of 12.0 mm, and a height of 5.0 mm. Thereafter, the wound body 40Z was placed inside the container part 11. The negative electrode lead 52 was welded to the container part 11 by the resistance welding method. Thereafter, the positive electrode lead 51 was welded to the external terminal 20 of the cover part 12 by the resistance welding method. The external terminal 20 was attached to the cover part 12 with the gasket 30 interposed therebetween. The external terminal 20 had the recessed part 12H. The recessed part 12H had the through hole 12K having an inner diameter of 3.0 mm. The recessed part 12H had an inner diameter of 9.0 mm and a height of a stepped part of 0.3 mm. The external terminal 20 had a disk shape and included aluminum. The external terminal 20 had a wall thickness of 0.3 mm and an outer diameter of 7.2 mm. The cover part 12 had a disk shape and included stainless steel (SUS316). The cover part 12 had a wall thickness of 0.15 mm and an outer diameter 11.7 mm. The gasket 30 included a polyimide film, and had an outer diameter of 9.2 mm and an inner diameter of 3.2 mm.

Thereafter, the electrolytic solution was injected into the container part 11 through the opening 11K in a state where the cover part 12 was raised relative to the container part 11. Thus, the wound body 40Z (including the positive electrode 41, the negative electrode 42, and the separator 43) was impregnated with the electrolytic solution, and the battery device 40 was fabricated.

Lastly, the opening 11K was closed with use of the cover part 12, following which the cover part 12 was welded to the container part 11 by the laser welding method. When the opening 11K was closed by the cover part 12, the turning part 513 was so formed in a portion of the positive electrode lead 51 as to form a curved shape, and the turning part 513 was positioned in the peripheral part 12R. Specifically, a distance between the turning part 513 and an inner surface of the sidewall part M3 was adjusted to be 0.5 mm. In addition, the insulating film 62 having a ring shape was disposed between the cover part 12 and the positive electrode lead 51, and the insulating film 63 having a disk shape was disposed between the battery device 40 and the positive electrode lead 51. The insulating film 62 was a polyimide film and had an outer diameter of 9.2 mm and an inner diameter of 3.2 mm. The insulating film 63 was a polyimide film and had an outer diameter of 3.2 mm. Thus, the outer package can 10 was formed with use of the container part 11 and the cover part 12, and the battery device 40 was sealed in the outer package can 10. As a result, the secondary battery was assembled. The secondary battery had an outer diameter of 12.0 mm and a height of 5.0 mm.

### [Stabilization of Secondary Battery]

The assembled secondary battery was charged and discharged for one cycle in an ambient temperature environment (at a temperature of 23° C.). Upon charging, the secondary battery was charged with a constant current of 0.1 C until a voltage reached 4.2 V, and was thereafter charged with a constant voltage of that value, 4.2 V, until a current reached 0.05 C. Upon discharging, the secondary battery was discharged with a constant current of 0.1 C until the voltage reached 3.0 V. Note that 0.1 C was a value of a current that caused a battery capacity (a theoretical capacity) to be completely discharged in 10 hours, and 0.05 C was a value of a current that caused the battery capacity to be completely discharged in 20 hours.

As a result, a film was formed on a surface of, for example, the negative electrode 42. This brought the secondary battery into an electrochemically stable state. The secondary battery was thus completed.

The secondary batteries fabricated as described above were each evaluated for performance. Specifically, the 100 secondary batteries having been fabricated as described above and having been subjected to one cycle of charging and discharging under the conditions described above were each disassembled to visually check the presence or absence of damage (cracking or breakage) to each of the negative electrode current collectors. The results are presented in Table 1.

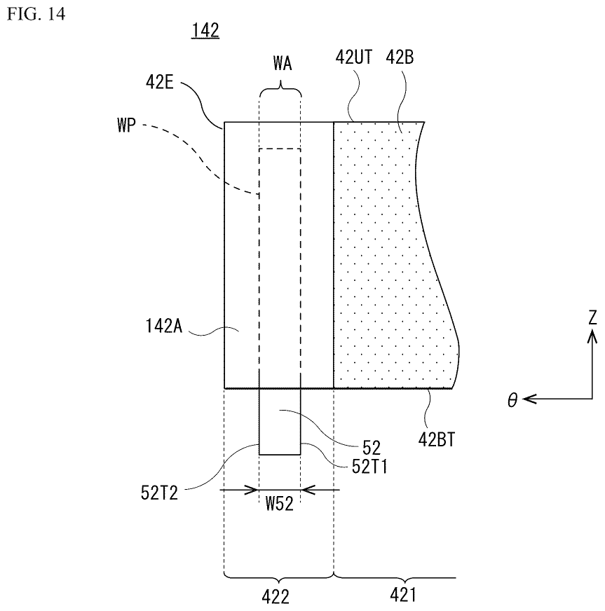

TABLE 1

| | | Cutout of | Presence or absence of |
|---|---|---|---|
| | | negative | cracking or breakage of |
| | | electrode | negative electrode current |
| | Corresponding | current | collector |
| | FIG. | collector | [out of 100 samples] |
| Example 1 | FIG. 6 | Present | 0 |
| Example 2 | FIG. 9 | Present | 0 |
| Example 3 | FIG. 10 | Present | 0 |
| Example 4 | FIG. 11 | Present | 0 |
| Example 5 | FIG. 12 | Present | 0 |
| Example 6 | FIG. 13 | Present | 0 |
| Comparative | FIG. 14 | Absent | 20 |
| example 1 | | | |

### Example 2

A hundred secondary batteries each including the negative electrode 42-1 illustrated in FIG. 9 were fabricated, following which the secondary batteries were each subjected to evaluation similar to that to which the secondary batteries of Example 1 were each subjected. The results are also presented in Table 1.

### Example 3

A hundred secondary batteries each including the negative electrode 42-2 illustrated in FIG. 10 were fabricated, following which the secondary batteries were each subjected to evaluation similar to that to which the secondary batteries of Example 1 were each subjected. The results are also presented in Table 1.

### Example 4

A hundred secondary batteries each including the negative electrode 42-3 illustrated in FIG. 11 were fabricated, following which the secondary batteries were each subjected to evaluation similar to that to which the secondary batteries of Example 1 were each subjected. The results are also presented in Table 1.

### Example 5

A hundred secondary batteries each including the negative electrode 42-4 illustrated in FIG. 12 were fabricated, following which the secondary batteries were each subjected to evaluation similar to that to which the secondary batteries of Example 1 were each subjected. The results are also presented in Table 1.

### Example 6

A hundred secondary batteries each having the negative electrode 42-5 illustrated in FIG. 13 were fabricated, following which the secondary batteries were each subjected to evaluation similar to that to which the secondary batteries of Example 1 were each subjected. The results are also presented in Table 1.

### Comparative Example 1

A hundred secondary batteries each including a negative electrode 142 illustrated in FIG. 14 were fabricated, following which the secondary batteries were each subjected to evaluation similar to that to which the secondary batteries of Example 1 were each subjected. The results are also presented in Table 1. The negative electrode 142 included a negative electrode current collector 142A having no cutout. Except for those described above, a configuration of the negative electrode 142 of Comparative example 1 was substantially the same as the configuration of the negative electrode 42 of an embodiment described above.

As indicated in Table 1, in Examples 1 to 6, no cracking and no breakage of the negative electrode current collector occurred. In contrast, in Comparative example 1, cracking and breakage of the negative electrode current collector were observed in 20 secondary batteries out of the 100 secondary batteries. It was presumed from these results that, in Comparative example 1, because the lower side edge 42BT intersecting the negative electrode lead 52 was orthogonal to the edges 52T1 and 52T2 of the negative electrode lead 52, stress was locally applied to a portion, of the negative electrode current collector 42A, that was provided with the negative electrode lead 52 due to expansion and contraction of the battery device 40 upon charging and discharging, resulting in the portion being stretched. In contrast, in Examples 1 to 6, it was considered that because the lower side edge 42BT intersecting the negative electrode lead 52 obliquely intersected the edges 52T1 and 52T2 of the negative electrode lead 52, it was possible to reduce a load on the negative electrode current collector 42A.

Although the present technology has been described herein with reference to one or more embodiments including Examples, the configuration of the present technology is not limited thereto, and is therefore modifiable in a variety of ways.

For example, although the description has been given of the case where the outer package can is a welded can (a crimpless can), the outer package can is not particularly limited in configuration, and may be a crimped can which has undergone crimping processing. In the crimped can, a container part and a cover part separate from each other are crimped to each other with a gasket interposed between the container part and the cover part.

Further, in an embodiment described above, the description has been given of the example case in which the negative electrode current collector has the cutout in a portion thereof; however, the present disclosure is not limited thereto. For example, the positive electrode current collector may have a cutout at a location where the positive electrode lead is joined in the positive electrode current collector.

In addition, in an embodiment described above, the description has been given of the example case in which the outer package can that contains the battery device also serves as the external coupling terminal to be coupled to a lead; however, the present disclosure is not limited thereto. For example, the external coupling terminal may be provided aside from the outer package can. In addition, in an embodiment described above, the negative electrode lead has been described as an example of the lead; however, the lead of the present disclosure may be the positive electrode lead 51 that couples the external terminal 20 and the positive electrode 41 to each other.

Further, although the description has been given of the case where the electrode reactant is lithium, the electrode reactant is not particularly limited. Accordingly, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present disclosure are therefore not limited to those described herein. Accordingly, the present disclosure may achieve any other effect.

The present disclosure may further include the following embodiments.

<1>

A secondary battery including:
a battery device including a first electrode and a second electrode that are stacked with a separator interposed between the first electrode and the second electrode, and are wound around a winding axis extending in a first direction;
an external coupling terminal; and
a lead that includes two opposed edges, and couples the first electrode and the external coupling terminal to each other, wherein
the first electrode includes a first electrode current collector and a first electrode active material layer, the first electrode current collector including a first edge, the first electrode active material layer covering a portion of the first electrode current collector, and
the lead is joined to the first electrode current collector in a state where the two opposed edges are inclined relative to the first edge.
   <2>

The secondary battery according to <1>, in which the first electrode current collector has a cutout at the first edge.

<3>

The secondary battery according to <1> or <2>, in which
the first electrode includes a first electrode current collector covered region where the first electrode current collector is covered with the first electrode active material layer, and a first electrode current collector exposed region where the first electrode current collector is exposed without being covered with the first electrode active material layer, and
the lead is joined to a portion of the first electrode current collector in the first electrode current collector exposed region.
   <4>

The secondary battery according to <3>, in which length in the first direction of a joining region of the first electrode current collector is shorter than a length in the first direction of the first electrode current collector in the first electrode current collector covered region, the joining region including a joined part joined to the lead.

<5>

The secondary battery according to any one of <1> to <4>, in which
the first electrode current collector has an inner side first electrode surface facing toward a side of the winding axis, and an outer side first electrode surface positioned on an opposite side to the inner side first electrode surface, and
the lead is joined to the inner side first electrode surface.
   <6>

The secondary battery according to any one of <1> to <5>, in which a joined part, of the lead, that is joined to the first electrode current collector extends in the first direction.

<7>

The secondary battery according to any one of <1> to <6>, in which the first edge is curved.

<8>

The secondary battery according to any one of <1> to <7>, in which the first electrode comprises a negative electrode, and the second electrode comprises a positive electrode.

<9>

The secondary battery according to any one of <1> to <8>, further including an outer package can that contains the battery device, in which
the outer package can also serves as the external coupling terminal.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a battery device including a first electrode and a second electrode that are stacked with a separator interposed between the first electrode and the second electrode, and are wound around a winding axis extending in a first direction;
an external coupling terminal; and
a lead that includes two opposed edges, and couples the first electrode and the external coupling terminal to each other, wherein
the first electrode includes a first electrode current collector and a first electrode active material layer, the first electrode current collector including a first edge, the first electrode active material layer covering a portion of the first electrode current collector, and
the lead is joined to the first electrode current collector in a state where the two opposed edges are inclined relative to the first edge.

2. The secondary battery according to claim 1, wherein the first electrode current collector has a cutout at the first edge.

3. The secondary battery according to claim 1, wherein
the first electrode includes a first electrode current collector covered region where the first electrode current collector is covered with the first electrode active material layer, and a first electrode current collector exposed region where the first electrode current collector is exposed without being covered with the first electrode active material layer, and
the lead is joined to a portion of the first electrode current collector in the first electrode current collector exposed region.

4. The secondary battery according to claim 3, wherein a length in the first direction of a joining region of the first electrode current collector is shorter than a length in the first direction of the first electrode current collector in the first electrode current collector covered region, the joining region including a joined part joined to the lead.

5. The secondary battery according to claim 1, wherein
the first electrode current collector has an inner side first electrode surface facing toward a side of the winding axis, and an outer side first electrode surface positioned on an opposite side to the inner side first electrode surface, and
the lead is joined to the inner side first electrode surface.

6. The secondary battery according to claim 1, wherein a joined part, of the lead, that is joined to the first electrode current collector extends in the first direction.

7. The secondary battery according to claim 1, wherein the first edge is curved.

8. The secondary battery according to claim 1, wherein the first electrode comprises a negative electrode, and the second electrode comprises a positive electrode.

9. The secondary battery according to claim 1, further comprising an outer package can that contains the battery device, wherein
the outer package can also serves as the external coupling terminal.
